(19) United States
(12) Patent Application Publication
(10) Pub. No.: US 2017/0176985 A1
(43) Pub. Date: Jun. 22, 2017

(54) METHOD FOR PREDICTING END OF LINE QUALITY OF ASSEMBLED PRODUCT

(71) Applicant: Caterpillar Inc., Peoria, IL (US)

(72) Inventors: Rahul Gajkumar Chougule, Bangalore (IN); Michael A. A'Hearn, Germantown Hills, IL (US); Cary J. Lyons, Morton, IL (US); Ben P. Slater, Peoria, IL (US); Gary E. Bright, Pontiac, IL (US); Keith Joseph Lensing, Peoria, IL (US); Yihong Yang, Champaign, IL (US)

(73) Assignee: Caterpillar Inc., Peoria, IL (US)

(21) Appl. No.: 15/450,028

(22) Filed: Mar. 6, 2017

(51) Int. Cl. G05B 19/418

(52) U.S. Cl. CPC G05B 19/41875; G05B 2219/32194

(57) ABSTRACT

A method for predicting an End of Line (EOL) quality of a product in an assembly plant is provided. The method includes performing a downstream test on a plurality of sub-components for determining a set of attributes. The method also includes receiving, by a control module, the set of attributes of the sub-components. The method further includes performing, by the control module, a root cause investigation on the set of attributes of the sub-components for identifying a subset of attributes from the set of attributes. The subset of attributes contributes to lowering the EOL quality of the assembled product. The method includes developing and validating, by the control module, dynamic prediction models based on the identified subset of attributes associated with the sub-components. The method also includes predicting, by the control module, the EOL quality of the assembled product based on the dynamically validated prediction model.

### TECHNICAL FIELD

The present disclosure relates to a system and method for predicting an End of Line (EOL) quality, and more particularly to the system and method for predicting the EOL quality of an assembled product.

### BACKGROUND

A product or assembled product may include a number of sub-components that must each meet physical and functional characteristics to ensure the product meets specified manufacturing criteria. In an assembly plant, the sub-components of the product may be manufactured at different sub-assembly lines or workstations before the product is finally assembled. Typically, before assembling the sub-components to form the final product, several downstream operations such as, part manufacturing, sub-assembly inspection, and sub-component quality testing are performed in the assembly plant. Further, the final assembled product is also tested to determine an End of Line (EOL) quality of the final product.

If the EOL test results meet expectations, the product may be dispatched for sale. However, low EOL test results may be indicative of low quality of the product, leading to considerable rework or rejection of the product. Rework or rejection of the product may incur significant losses in terms of time, effort, and cost associated with the manufacturing of the product, which is not desirable.

U.S. Pat. No. 8,774,956, hereinafter referred to as '956 patent, describes a method and apparatus for performing automated actions in response to yield predictions in an equipment engineering system. The yield prediction is received by a strategy engine. The strategy engine compares the end-of-line yield prediction to a plurality of rules. The strategy engine then instructs a component of an equipment engineering system to perform an action included in a rule that corresponds to the end-of-line yield prediction. However, the '956 patent does not describe a method to predict EOL quality of an assembled product.

### SUMMARY OF THE DISCLOSURE

In one aspect of the present disclosure, a method for predicting an End of Line (EOL) quality of a product in an assembly plant is provided. The method includes performing a downstream test on a plurality of sub-components for determining a set of attributes. The method also includes receiving, by a control module, the set of attributes of the sub-components. The method further includes performing, by the control module, a root cause investigation on the set of attributes of the sub-components for identifying a subset of attributes from the set of attributes. The subset of attributes contributes to lowering the EOL quality of the assembled product. The method includes developing and validating, by the control module, dynamic prediction models based on the identified subset of attributes associated with the sub-components. The method also includes predicting, by the control module, the EOL quality of the assembled product to be formed after the assembly based on the dynamically validated prediction model.

Other features and aspects of this disclosure will be apparent from the following description and the accompanying drawings.

### BRIEF DESCRIPTION OF THE DRAWINGS

FIG. 1 is a schematic diagram of an exemplary assembly plant, according to various concepts of the present disclosure;

FIG. 2 is a block diagram of a system for predicting an End of Line (EOL) quality of an assembled product manufactured and assembled in the assembly plant of FIG. 1, according to various concepts of the present disclosure; and

FIG. 3 is a flowchart for a method of predicting the EOL quality of the assembled product manufactured and assembled in the assembly plant of FIG. 1, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

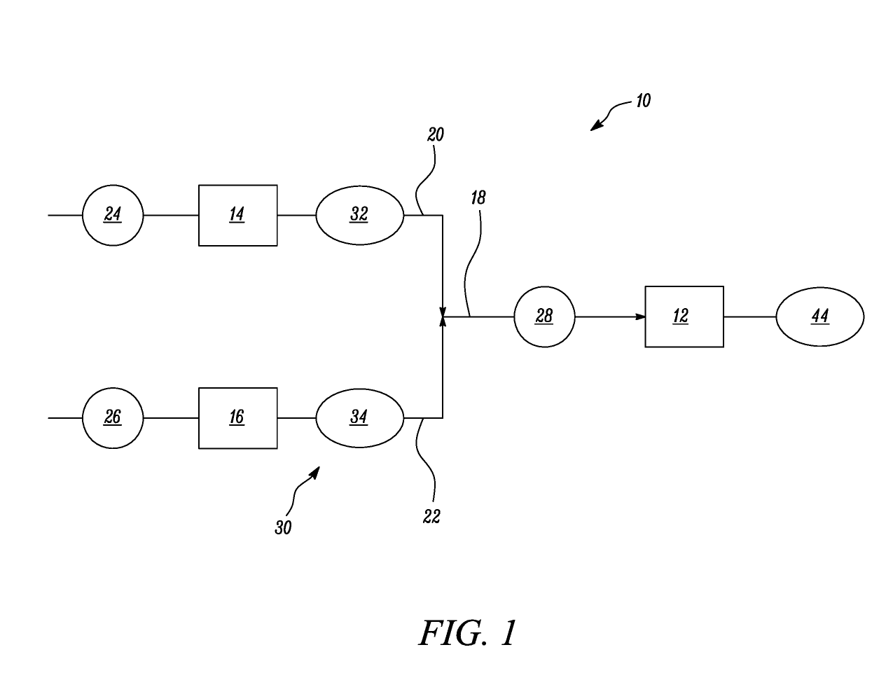

FIG. 1 is a schematic diagram of an exemplary assembly plant 10 for manufacturing and assembling a product 12. The product 12 is embodied as an assembled product that may include a number of sub-components, and may be hereinafter interchangeably referred to as the assembled product 12, without limiting the scope of the present disclosure. In the illustrated example, the product 12 includes a first sub-component 14 and a second sub-component 16. However, a number of the sub-components may vary, without any limitations.

The assembly plant 10 includes a final assembly line 18. The first and second sub-components 14, 16 are assembled in the final assembly line 18 to form the product 12. Further, the final assembly line 18 includes a final assembly unit 28 for assembling the first and second sub-components 14, 16 to form the product 12. The assembly plant 10 also includes a first sub-assembly line 20 and a second sub-assembly line 22. The first and second assembly lines 20, 22 are embodied as parallel assembly lines, without limiting the scope of the present disclosure. Further, each of the assembly lines 18, 20, 22 include a start point and an end point. The end points of the first and second assembly lines 20, 22 are connected to the start point of the final assembly line 18. In some examples, the assembly plant 10 also includes an inventory of sub-components.

Parts or components of the first sub-component 14 and the second sub-component 16 enter the respective first and second assembly lines 20, 22, through the respective start points of the first and second assembly lines 20, 22. The first sub-component 14 is manufactured and assembled in the first sub-assembly line 20. Whereas, the second sub-component 16 is manufactured and assembled in the second sub-assembly line 22. Each of the first and second assembly lines 20, 22 include a first and second manufacturing and assembly units 24, 26, respectively, for manufacturing and assembling the first and second sub-components 14, 16, respectively. After manufacturing and assembly, the first and second components 14, 16 exit through the end points of the respective assembly lines 20, 22, to enter the final assembly line 18. In one example, the first and second components 14, 16 exits through the end points of the respective assembly lines 20, 22 and are stored as work in-process inventory.

It should be noted that the product 12 may belong to an industry such as, but not limited to, mining, construction, farming, earthmoving, packaging, food, or any another industry known in the art. In one example, the product 12 may embody a machine such as an excavator or a wheel loader. In another example, the product 12 may embody an engine of the machine, or any other part, such as a fuel injector associated with the engine, without any limitations.

The present disclosure relates to a system 30 for predicting an End of Line (EOL) quality of the product 12 manufactured and assembled in the assembly plant 10. The system 30 includes a first test unit 32 and a second test unit 34. The first and second test units 32, 34 are located at a downstream end of the first and second manufacturing and assembly units 24, 26. Further, a final test unit 44 of the system 30 is located at a downstream end of the final assembly unit 28, close to the end point of the final assembly line 18.

The first and second test units 32, 34 are used to perform downstream tests on the first and second sub-components 14, 16, prior to the assembly. The downstream tests on the first and second sub-components 14, 16 are performed to determine a set of attributes of the respective sub-components 14, 16. The attributes may include attribute values corresponding to metrology data of the first and second sub-components 14, 16, attribute values corresponding to the first and second manufacturing and assembling units 24, 26, or attribute values corresponding to the first and second test units 32, 34.

The metrology data corresponding to the first and second sub-components 14, 16 may include dimensions of the first and second sub-components 14, 16 or, pressures or temperatures of the first and second sub-components 14, 16. Further, the attribute values corresponding to the first and second manufacturing and assembling units 24, 26 may include environmental data such as pressure or temperature in the first and second manufacturing and assembling units 24, 26 during the manufacturing and assembly of the first and second sub-components 14, 16, force or torque applied during the assembly of the first and second sub-components 14, 16, without any limitations. The attribute values corresponding to the first and second test units 32, 34 may include data corresponding to performance of the first and second test units 32, 34, without any limitations. For example, the attribute values corresponding to the first and second test units 32, 34 may include accuracy or variability, and any other characteristics of the first and second test units 32, 34 that may affect the results of the downstream tests performed by the first and second test units 32, 34 on the product 12.

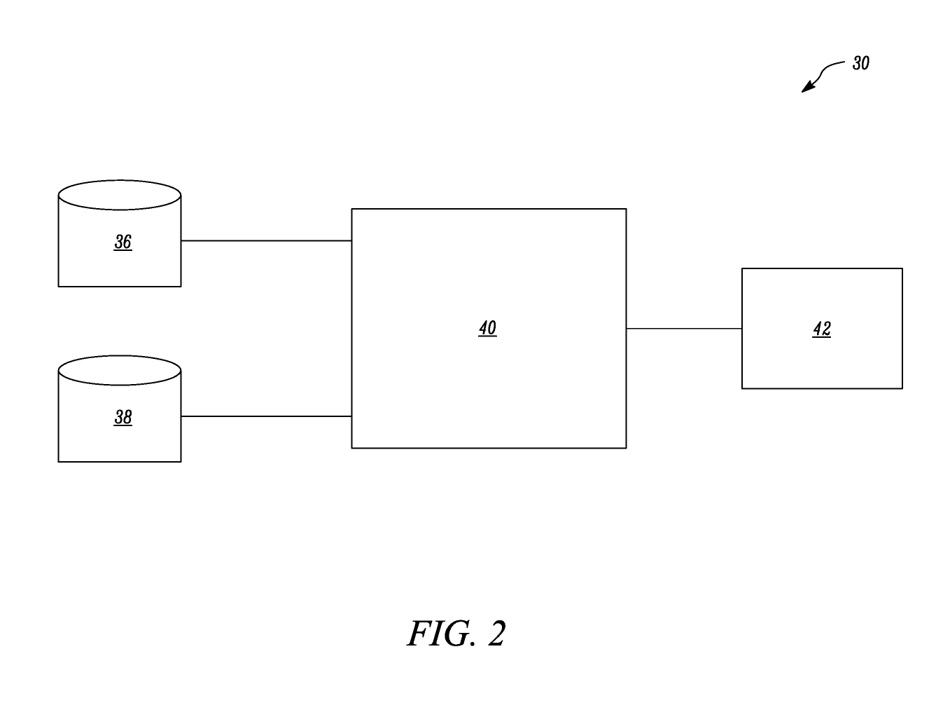

Referring now to FIG. 2, the system 30 includes a first database 36 and a second database 38. The set of attributes determined during the downstream tests on the first and second sub-components 14, 16 (see FIG. 1) are sent and stored in the first and second databases 36, 38, respectively. The first and second databases 36, 38 may include online or offline data repository, external data source, or cloud. The first and second databases 36, 38 may include a single consolidated database or multiple databases based on system requirements. In one example, the system 30 may include a single database that stores the determined set of attributes of each of the first and second sub-components 14, 16, without any limitations.

In some examples, barcode scanning or RFID scanning of the first and second sub-components 14, 16 may be performed to link test data of the first and second sub-components 14, 16, so that only the data corresponding to the first and second sub-components 14, 16 that go into final assembly is retrieved and used for prediction of the EOL quality of the product 12 (see FIG. 1).

The system 30 also includes a control module 40. The control module 40 may run an algorithm for predicting the EOL quality of the product 12. The control module 40 is communicably coupled to the first and second databases 36, 38. The control module 40 retrieves data corresponding to the set of attributes of the respective sub-components 14, 16 from the respective first and second databases 36, 38. Further, the control module 40 also retrieves data corresponding to EOL quality test results.

The control module 40 may also receive data of shift timings at which the manufacturing and assembly of the first and second sub-components 14, 16 were being performed. In some examples, the control module 40 may also receive data corresponding to a personnel in charge of the manufacturing and assembly of the first and second sub-components 14, 16. Further, the algorithm run by the control module 40 is programmed to perform a root cause investigation on the determined set of attributes of the first and second sub-components 14, 16. It should be noted that the data corresponding to the shift timings and personnel data may also be considered as attributes and are used to perform the root cause investigation.

For root cause investigation purposes, the algorithm run by the control module 40 is programmed to perform one or more tests to determine a pattern or combination of the first or second sub-components 14, 16 that has a high probability of lowering the EOL quality of the product 12. For example, the tests may determine if any one of a combination of the first and second sub-components 14, 16, the respective first and second manufacturing and assembly units 24, 26, or the respective first and second test units 32, 34 has a high probability of lowering the EOL quality of the product 12 or causing failure of the product 12. The combinations are determined based on analysis performed on the set of attributes of each of the first and second sub-components 14, 16.

In one example, the algorithm run by the control module 40 may perform an association mining test to determine the combinations that may lower the EOL quality of the product 12 or cause rejection of the product 12. The association mining test includes creation of association rules by analyzing data for frequent combinations and using the criteria of support and confidence to identify combinations that either frequently fail or lower the EOL quality of the product 12. Further, using the association mining test, the control module 40 may determine factors contributing to the low EOL quality of the product 12. For example, the control module 40 may determine if the first or second manufacturing and assembly units 24, 26 or the first or second test units 32, 34 are lowering the EOL quality of the product 12.

Further, the algorithm run by the control module 40 is programmed to identify a subset of attributes from the determined combinations that lower the EOL quality of the product 12. The term “subset of attributes” referred to herein is indicative of the attributes of the first and second sub-components 14, 16, belonging to the determined combinations, which contribute towards lowering the EOL quality of the product 12. The algorithm may perform any one or more of a T-test, random forest test, or information value criteria, without any limitations, for determining the subset of attributes. For example, for a sub-component of an engine, such as a fuel injector, the subset of attributes may include an air gap, flow meter temperature, or arm size, without any limitations. In some examples, the algorithm may be programmed to compare the set of attributes belonging to the determined combinations with respective predetermined thresholds in order to identify the subset of attributes. It should be noted that “T-test” is a sampling test that is performed to identify if two samples are statistically different from each other, with respect to individual parameters.

Further, the algorithm run by the control module 40 is programmed to develop dynamic prediction models. The dynamic prediction models are developed using predictors in order to predict the EOL quality of the product 12, based on the subset of attributes. In the illustrated example, the predictors are the subset of attributes that are determined during the root cause investigation performed by the control module 40. The dynamic prediction models may include any one of a linear discriminant analysis, logistic regression, neural network, random forest, support vector machine (SVM), or any other dynamic prediction models known in the art. It should be noted that dynamic prediction models are chosen to predict the EOL quality of the product 12 as the subset of attributes may vary for different products.

Based on the development of the dynamic prediction models, the control module 40 is programmed to validate the dynamic prediction models. The validation of dynamic prediction models allows determination of the most accurate dynamic prediction model, based on system requirements. The dynamic prediction models may be validated using statistical tests such as N fold cross validation, confusion matrix, ROC curve, partition plots, without any limitations. Further, the control module 40 uses the dynamically validated prediction model to predict the EOL quality of the product 12 using the subset of attributes as the predictors.

The control module 40 may compare the predicted EOL quality with an expected EOL quality to notify a personnel whether the product 12 meets quality expectations. In one example, if the predicted EOL quality is less than the expected EOL quality, the personnel may be notified, via an output module 42, that the product 12 is at risk and may fail a EOL quality test that is performed after the assembly of the product 12. In another example, the output module 42 may display a predicted EOL quality value of the product 12, in terms of percentage, based on inputs received from the control module 40. The output module 42 of the system 30 is communicably coupled to the control module 40, and may embody any known in the art audio or visual display unit, without any limitations.

The system 30 can also be used to predict a EOL quality of the first and second sub-components 14, 16, as per system requirements. In such an example, the first and second sub-components 14, 16 may in turn include a number of components that are assembled to form the respective first and second sub-components 14, 16. Further, the control module 40 may receive attributes corresponding to the components of the respective first and second sub-components 14, 16, based on downstream tests performed thereon. The control module 40 may perform root cause investigation on the attributes to determine the subset of attributes. The subset of attributes is then used to develop and run dynamic prediction models to predict the EOL quality of the first and second sub-components 14, 16. Further, the manufacturing/testing of the sub-components 14, 16 can happen at geographically dispersed locations or at supplier facility. However, data from various locations can be integrated by the system 30 for root cause investigation and prediction of the EOL quality.

In yet another example, the system 30 is used to predict the EOL quality of other unassembled products using data of the downstream tests performed on the first and second sub-components 14, 16 and the EOL quality of the product 12. In such an example, the EOL quality of the product 12 is measured by the final test unit 44 (see FIG. 1). In some examples, the downstream data and EOL quality of various products may be stored in a database (not shown), and may be retrieved by the control module 40 therefrom. Thus, the attributes from the downstream tests and the EOL quality may be used as predictors to develop and run dynamic prediction models to predict the EOL quality of unassembled products.

### INDUSTRIAL APPLICABILITY

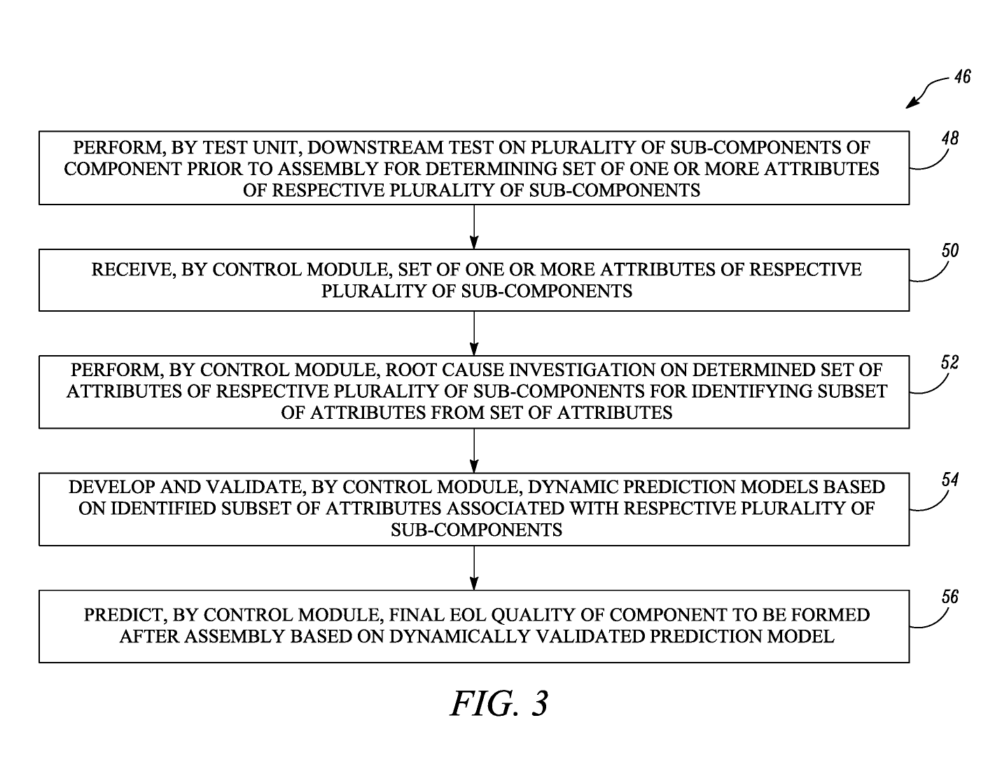

The present disclosure relates to a method 46 and the system 30 to predict the EOL quality of the product 12. The method 46 for predicting the EOL quality of the product 12 in the assembly plant 10 will now be explained with reference to FIG. 3. At step 48, the test units 32, 34 perform the downstream test on the first and second sub-components 14, 16 of the product 12 prior to assembly for determining the set of attributes of the first and second sub-components 14, 16. At step 50, the control module 40 receives the set of attributes of the respective sub-components 14, 16 from the databases 36, 38.

At step 52, the control module 40 performs the root cause investigation on the determined set of attributes of the first and second sub-components 14, 16 for identifying the subset of attributes from the set of attributes. The subset of attributes is indicative of the attributes that contribute to lowering the EOL quality of the product 12. At step 54, the control module 40 develops and validates dynamic prediction models based on the identified subset of attributes associated with the first and second sub-components 14, 16. At step 56, the control module 40 predicts the EOL quality of the product 12 to be formed after the assembly based on the dynamically validated prediction models. The dynamic prediction models may include any one of the linear discriminant analysis, logistic regression, neural network, random forest, or support vector machine, without any limitations.

Further, the control module 40 also predicts the EOL quality of other unassembled products including the first and second sub-components 14, 16 of the product 12 based on data corresponding to the downstream tests performed on the components of the first and second sub-components 14, 16 and the EOL quality of the product 12. The method 46 may also be used to predict a trend of EOL quality of unassembled products.

The method 46 described above provides a way to assess factors contributing to the lowering of the EOL quality of the product 12. Also, the method 46 aids manufacturing and design engineers in effective use of downstream data in root cause investigation of quality issues. Further, the method 46 disclosed herein helps in determination of factors that have a significant impact on the EOL quality. Thus, such factors can be more closely controlled and monitored to improve the EOL quality. The method 46 disclosed herein helps in improving an EOL test pass rate. Also, the method 46 may reduce time, efforts, and complexity involved with the EOL quality testing of the product 12.

Further, the manufacturing/testing of the sub-components 14, 16 can be performed at geographically dispersed locations or at the supplier facility. However, the method 46 and the system 30 disclosed herein can integrate the data of the sub-components 14, 16 from various locations, and use the data for root cause investigation and prediction of the EOL quality.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for predicting an End of Line (EOL) quality of an assembled product in an assembly plant, the method comprising:
performing, a downstream test on a plurality of sub-components for determining a set of attributes;
receiving, by a control module, the set of attributes of the sub-components;
performing, by the control module, a root cause investigation on the set of attributes of the sub-components for identifying a subset of attributes from the set of attributes, wherein the subset of attributes contributes to lowering the EOL quality of the assembled product;
developing and validating, by the control module, dynamic prediction models based on the identified subset of attributes associated with the sub-components; and
predicting, by the control module, the EOL quality of the assembled product to be formed after the assembly based on the dynamically validated prediction model.

2. The method of claim 1 further comprising:
predicting, by the control module, a EOL quality of other unassembled assembled products including one or more of the sub-components of the assembled product based on data corresponding to at least one of the downstream tests and the predicted EOL quality of the assembled product.

3. The method of claim 1, wherein the dynamic prediction model includes at least one of a linear discriminant analysis, logistic regression, neural network, random forest, and support vector machine.
